(19) United States
(12) Patent Application Publication
(10) Pub. No.: US 2011/0154938 A1
(43) Pub. Date: Jun. 30, 2011

(54) ROBOT ARM ASSEMBLY

(75) Inventors: JUN LIU, Shenzhen City (CN); CHUN-MING ZHANG, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/913,963

(22) Filed: Oct. 28, 2010

(30) Foreign Application Priority Data
Dec. 30, 2009 (CN) 200910312664.0

(51) Int. Cl. B25J 17/00; B25J 18/00

(52) U.S. Cl. 74/490.05; 901/28; 901/15

(57) ABSTRACT

A robot arm assembly includes a first joint, a second joint and a flange. The second joint is rotatably connected to the first joint. The flange is fixed on the second joint. The first joint includes a rotary connecting portion located on an end of the first joint and a limiting portion adjacent to the rotary connecting portion. The flange defines a through hole in a middle portion of the flange and an open ring groove around the through hole. A curve of the open ring groove is less than 360°. The rotary connecting portion passes through and is received in the through hole. The limiting portion slides in the open ring groove.

### BACKGROUND

1. Technical Field

The present disclosure relates to robotic technologies, and particularly, to a robot arm assembly.

2. Description of the Related Art

Industrial robots generally include robot arm assemblies pivotally connected in sequence. Each arm assembly can rotate relative to the others when driven by a motor. Performance parameters such as precision, loading ability, and stability are determined by the position relationships and the driving relationships among the components arranged at a plurality of pivotal portions of the robot arm assemblies.

A commonly used robot arm assembly includes a first joint, a second joint, a flange, and a rotary bearing. The first joint is substantially cylindrical and rotatably connected to the second joint. The second joint and the flange are received in the first joint. The rotary bearing is sleeved on the second joint. The flange is fixed on an open end of the second joint, such that the rotary bearing is limited in the first joint. The robot arm assembly provides a plurality of electrical circuit cables and an airflow duct located between the first joint and the second joint. However, when the second joint rotates relative to the first joint at an angle less than 360°, the electrical circuit cables and the airflow duct are easily damaged due to excessive distortion thereof.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is an exploded, isometric view of one embodiment of a robot arm assembly including a first joint, a second joint and a flange.

FIG. 2 is similar to FIG. 1, but viewed from another aspect.

FIG. 3 is an isometric view of the flange shown in FIG. 1

FIG. 4 is an assembled, isometric view of the robot arm assembly shown in FIG. 1.

FIG. 5 is a cross-sectional isometric view of the robot arm assembly shown in FIG. 1.

### DETAILED DESCRIPTION

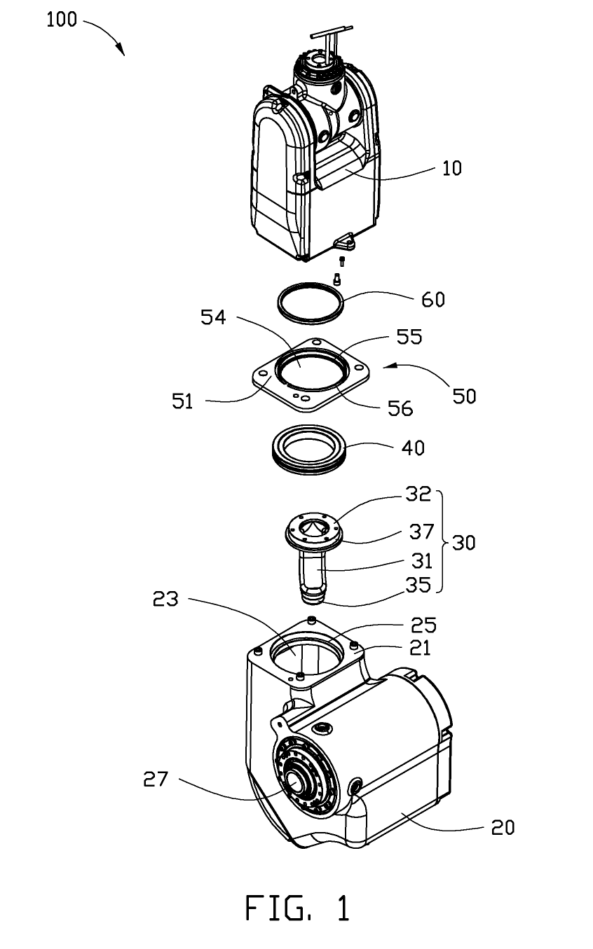

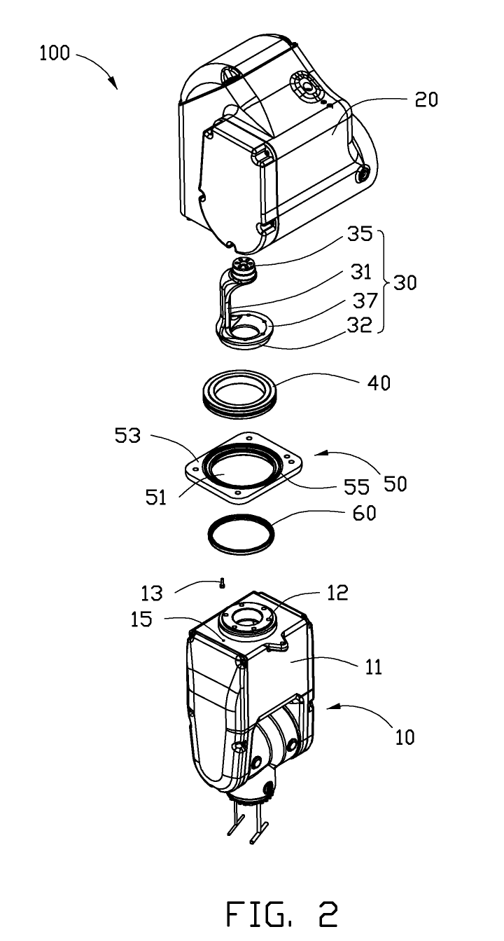

Referring to FIGS. 1 and 2, one embodiment of a robot arm assembly 100 includes a first joint 10, a second joint 20, a rotary member 30, a bearing 40, a flange 50, and a limiting member 60. The rotary member 30 is received in the second joint 20 and fixed to the first joint 10. The bearing 40 and the flange 50 are sleeved on the rotary member 30. The flange 50 is fixed on the second joint 20, such that the bearing 40 is prevented from detaching from the second joint 20. The limiting member 60 is located on the flange 50 to prevent the first joint 10 deviating from an axis of the first joint 10.

The first joint 10 includes a main body 11, a rotary connecting portion 12, and a limiting portion 13. The rotary connecting portion 12 is substantially ring-shaped, and located on an end of the main body 11. The limiting portion 13 is located adjacent to the rotary connecting portion 12. The first joint 10 further defines a fixing hole 15 in the end of the first joint 10. In the illustrated embodiment, the limiting portion 13 is a threaded member received in the fixing hole 15.

The second joint 20 includes a mounting portion 21, a receiving portion 23, a stepped hole 25, and a driving member 27. The receiving portion 23 is defined in a middle portion of the second joint 20. The stepped hole 25 is defined in the mounting portion 21 communicating with the receiving portion 23. The rotary member 30 and the bearing 40 are received in the receiving portion 23. A larger end of the stepped hole 25 is defined in a side surface of the second joint 20. The driving member 27 drives the rotary member 30 to rotate. In the illustrated embodiment, the driving member 27 is a stepper motor.

The rotary member 30 includes an axial portion 31, a first connecting portion 32, a second connecting portion 35, and a resisting portion 37. The first connecting portion 32 and the second connecting portion 35 are located on opposite ends of the axial portion 31, respectively. The first connecting portion 32 is connected to the first joint 10. The second connecting portion 35 is connected to the driving member 27. The resisting portion 37 is positioned at an end of the first connecting portion 32 adjacent to the axial portion 31.

The bearing 40 is substantially circular, and a cross-section of the bearing 40 is substantially rectangular. A diameter of the bearing 40 is less than the maximum diameter of the stepped hole 25 of the second joint 20, and exceeds the minimum diameter of the stepped hole 25, such that the bearing 40 is prevented from detaching from the stepped hole 25.

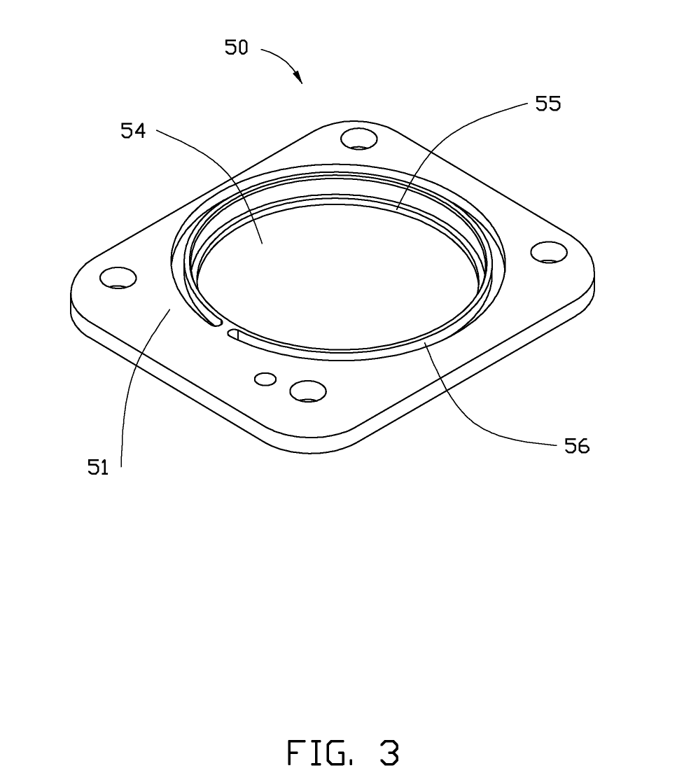

Referring to FIGS. 2 and 3, the flange 50 is substantially rectangular, and includes a first end surface 51 and a second end surface 53 opposite to the first end surface 51. The flange 50 defines a circular through hole 54 in a middle portion of the first end surface 51 and an open ring groove 56 around the through hole 54. A curve of the open ring groove 56 is less than 360°. The flange 50 further includes a ring protrusion 55 located on a middle portion of an inner surface of the through hole 54. In the illustrated embodiment, the curve of the open ring groove 56 is about 345°.

The limiting member 60 is substantially ring shaped. A diameter of the limiting member 60 is less than that of the through hole 54. The limiting member 60 is received in the through hole 54, and resists the ring protrusion 55.

The robot arm assembly 100 further includes a plurality of electrical circuit cables and an airflow duct (not shown). The airflow duct passes through the rotary member 30, the first joint 10 and the second joint 20.

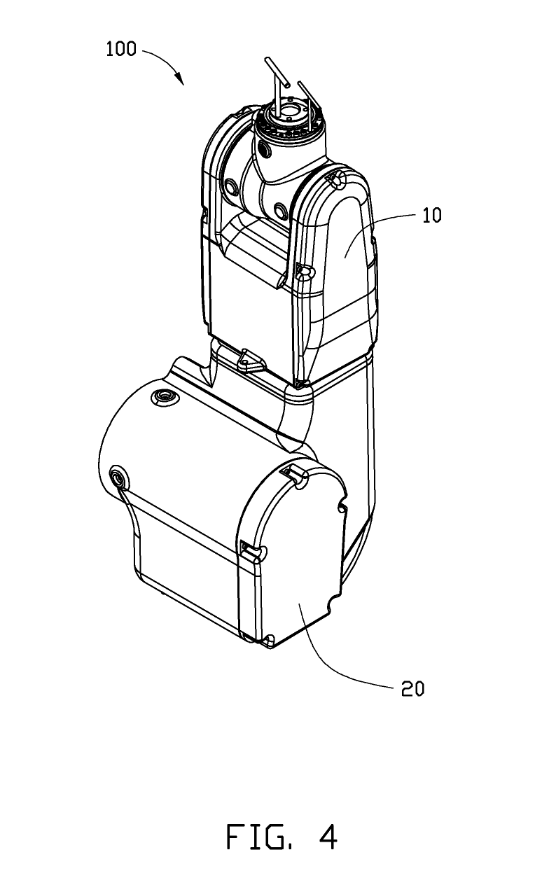

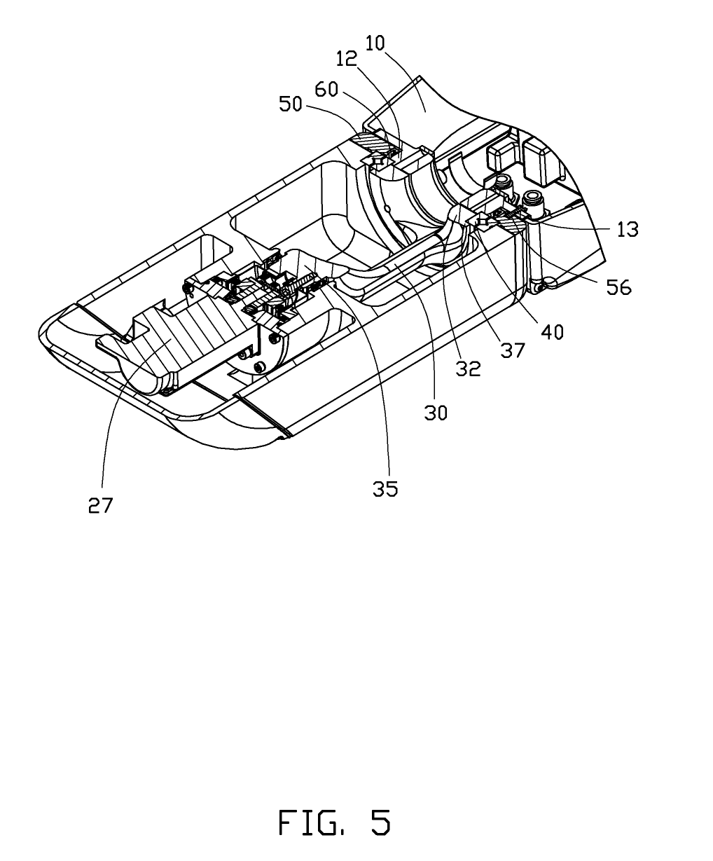

Referring to FIGS. 1, 4 and 5, during assembly of the robot arm assembly 100, the rotary member 30 is received in the receiving portion 23 of the second joint 20 via the stepped hole 25. The second connecting portion 35 of the rotary member 30 is fixed to the driving member 27. The bearing 40 is received in the stepped hole 25 of the second joint 20, and contacts the resisting portion 37. The flange 50 is fixed to the mounting portion 21 of the second joint 20, such that the bearing 40 is partially received in the through hole 54. The limiting member 60 is received in the through hole 54, and resists the ring protrusion 55. The rotary connecting portion 12 of the first joint 10 is received in the through hole 54, and connected to the second connecting portion 35 of the rotary member 30. A free end of the limiting portion 13 of the first joint 10 is received in the open ring groove 56 of the flange 50.

When the first joint 10 is rotated relative to the second joint 20, the limiting portion 13 of the first joint 10 slides in the open ring groove 56, and is stopped at the end of the open ring groove 56, such that a rotation angle of the first joint 10 is less than 360°. Thereby, the robot arm assembly 100 can protect the electrical circuit cables and the airflow from being damaged due to excessive distortion.

Finally, while the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure as defined by the appended claims.

What is claimed is:

1. A robot arm assembly comprising:
a first joint,
a second joint rotatably connected to the first joint; and
a flange fixed on the second joint, wherein the first joint comprises a rotary connecting portion located on an end of the first joint and a limiting portion adjacent to the rotary connecting portion, the flange defines a through hole in a middle portion and an open ring groove around the through hole, a curve of the open ring groove is less than 360°, the rotary connecting portion received in the through hole, and the limiting portion slides in the open ring groove.

2. The robot arm assembly of claim 1, wherein the second joint comprises a mounting portion, and the flange is fixed on the mounting portion.

3. The robot arm assembly of claim 2, further comprising a rotary member fixed to the rotary connecting portion, and the second joint defining a receiving portion in a middle portion of the second joint to receive the rotary member.

4. The robot arm assembly of claim 3, wherein the second joint further defines a stepped hole in the mounting portion communicating with the receiving portion, the robot arm assembly further comprises a bearing received in the stepped hole.

5. The robot arm assembly of claim 4, wherein the rotary member comprises an axial portion, a first connecting portion and a second connecting portion located on opposite ends of the axial portion, respectively, and the first connecting portion is fixed to the rotary connecting portion.

6. The robot arm assembly of claim 5, wherein the rotary member further comprises a resisting portion arranged at an end of the first connecting portion adjacent to the axial portion, and the bearing contacts the resisting portion.

7. The robot arm assembly of claim 5, wherein the rotary member further comprises a driving member connected to the second connecting portion.

8. The robot arm assembly of claim 1, wherein the flange comprises a ring protrusion located on a middle portion of an inner surface of the through hole.

9. The robot arm assembly of claim 8, further comprising a limiting member received in the through hole and resisting the ring protrusion.

10. The robot arm assembly of claim 1, wherein the limiting portion is a threaded member.
